(19) United States
(12) Patent Application Publication
(10) Pub. No.: US 2019/0038486 A1
(43) Pub. Date: Feb. 7, 2019

(54) MOVING APPARATUS

(71) Applicant: EXEDY Corporation, Osaka (JP)

(72) Inventors: Keiji SATO, Osaka (JP); Hitoshi KATSURA, Osaka (JP); Taichi KITAMURA, Osaka (JP); Chika BABA, Osaka (JP)

(73) Assignee: EXEDY Corporation

(21) Appl. No.: 16/051,478

(22) Filed: Jul. 31, 2018

(30) Foreign Application Priority Data
Aug. 3, 2017 (JP) 2017-151088

(51) Int. Cl. A61G 5/10; A61G 5/04

(52) U.S. Cl. CPC A61G 5/10; A61G 5/04

(57) ABSTRACT

A moving apparatus is rideable by a caregiver and operable by a motor. The moving apparatus includes a main body and a first rotating body mounted on the main body so as to be rotatable around a first rotation axis. The moving apparatus also includes a second rotating body mounted on the main body so as to be rotatable around a second rotation axis. The second rotation axis is disposed spaced apart from the first rotation axis. The first rotating body and the second rotating body contact the ground. The main body is configured such that a wheelbase defined by the first rotation axis and the second rotation axis is changeable.

### CROSS-REFERENCE TO RELATED APPLICATIONS

This application claims priority to Japanese Patent Application No. 2017-151088, filed Aug. 3, 2017. The contents of that application are herein incorporated by reference in their entirety.

### TECHNICAL FIELD

The present disclosure relates to a moving apparatus, and particularly relates to a moving apparatus rideable by a caregiver and movable by a motor.

### BACKGROUND

In the related art, moving apparatuses such as electric wheelchairs have been proposed, on which both a care receiver and a caregiver can ride (see Japanese Unexamined Utility Model Application Publication No. H01-178019). Additionally, electric wheelchairs have been proposed in which a riding portion attached to the main body is foldable (see Japanese Unexamined Patent Application Publication No. 2005-176980).

### BRIEF SUMMARY

With the electric wheelchair described in Japanese Unexamined Utility Model Application Publication No. H01-178019, a riding portion must be provided to allow the caregiver to ride. Consequently, the size of the electric wheelchair may increase. With the electric wheelchair described in Japanese Unexamined Patent Application Publication No. 2005-176980, even though the riding portion for the caregiver is foldable, the wheel base of the electric wheelchair itself (the body of the electric wheelchair) does not change and, as such, maneuverability of the electric wheelchair may decline. Furthermore, with the electric wheelchair described in Japanese Unexamined Patent Application Publication No. 2005-176980, a wheel for the riding portion is especially provided and, consequently, the number of wheels increases, which may increase the overall weight.

In light of the problems described above, an object of the present disclosure is to provide a moving apparatus that achieves reduces in size and weight and improves its maneuverability as compared to before.

### Solutions to Problems

A moving apparatus according to one aspect of the present disclosure is a moving apparatus that is rideable by a caregiver and movable by a motor. The moving apparatus includes a main body, a first rotating body, and a second rotating body. The first rotating body is mounted on the main body so as to be rotatable around a first rotation axis. The second rotating body is mounted on the main body so as to be rotatable around a second rotation axis disposed spaced apart from the first rotation axis.

Here, the first rotating body and second rotating body contact the ground. The main body is configured such that a wheelbase defined by the first rotation axis and second rotation axis is changeable. With this moving apparatus, the size and the weight of the moving apparatus can be reduced, and the maneuverability can be improved by changing the wheelbase. Additionally, with this moving apparatus, the number of wheels is the same, regardless of whether the caregiver is riding on or off the main body and, as such, the weight of the moving apparatus can be reduced.

With a moving apparatus according to another aspect of the present disclosure, preferably the main body is configured such that, when the caregiver and a care receiver assisted by the caregiver are riding on the main body, a center of gravity of the caregiver and a center of gravity of the care receiver are positioned within the range of the wheelbase.

Positioning the center of gravity of the care receiver and the center of gravity of the caregiver within the range of the wheelbase makes it possible to realize stable maneuverability and runnability of the moving apparatus.

With a moving apparatus according to another aspect of the present disclosure, preferably the main body includes a first frame portion where the care receiver assisted by the caregiver rides, and a second frame portion where the caregiver rides. In this case, the first rotating body is mounted on the first frame portion, the second rotating body is mounted on the second frame portion, and the first rotating body and the second rotating body contact the ground, as described above.

The size and the weight of the moving apparatus can be reduced, and the maneuverability can be improved by changing the wheelbase while the first rotating body and the second rotating body are respectively mounted on the first frame portion and the second frame portion in this manner.

With a moving apparatus according to another aspect of the present disclosure, preferably the wheelbase is changed by approaching or moving away of the second frame portion from the first frame portion.

The size and the weight of the moving apparatus can be reduced, and the maneuverability can be improved by changing the wheelbase in this manner.

With a moving apparatus according to another aspect of the present disclosure, preferably the wheelbase is changed by folding of the second frame portion toward the first frame portion.

The size and the weight of the moving apparatus can be reduced, and the maneuverability can be improved by changing the wheelbase as described above.

With a moving apparatus according to another aspect of the present disclosure, preferably the first frame portion includes a main frame portion and a riding frame portion. The main frame portion is connected to the second frame portion. The riding frame portion, where the care receiver assisted by the caregiver rides, is detachably mounted on the main frame portion. The riding frame portion includes a third rotating body.

In this case, the size and the weight can be further reduced by removing the riding frame portion from the main frame portion. Additionally, indoor cleanliness can be ensured by using the first rotating body and the second rotating body outdoors and the third rotating body indoors.

With a moving apparatus according to another aspect of the present disclosure, the following configuration is preferable: one of the first rotating body and second rotating body is configured from at least two rotating bodies, and the other of the first rotating body and second rotating body is configured from at least one rotating body.

As a result of this configuration, the main body will be supported by at least three rotating bodies and, as such, stable maneuverability and runnability can be realized in the moving apparatus.

With a moving apparatus according to another aspect of the present disclosure, the following configuration is preferable: the first rotating body and second rotating body are respectively configured from at least two rotating bodies, a tread of the first rotating body is larger than a tread of the second rotating body, and the second rotating body is mounted on the main body so as to rotate around a cross axis intersecting with the second rotation axis.

As a result of this configuration, the second rotating body becomes easier to move inward from the first rotating body. For example, the trajectory on which the second rotating body moves can be located inward from the trajectory on which the first rotating body moves. As a result, motion of the second rotating body can be stabilized. For example, derailing of the second rotating body and contact of the second rotating body with moving bodies or stationary bodies can be prevented.

A moving apparatus according to another aspect of the present disclosure preferably further includes a support member. The support member supports the main body between the first rotation axis and second rotation axis when the wheelbase is changed. As a result of this configuration, the wheelbase can be easily and stably changed.

A moving apparatus according to another aspect of the present disclosure preferably further includes a control device. The control device is configured to control at least one of the first rotating body and the second rotating body.

As a result of this configuration, at least one of the first rotating body and the second rotating body can be suitably moved.

With a moving apparatus according to another aspect of the present disclosure, preferably the control device includes a first control unit. The first control unit is configured to control the rotation speed of at least one of the first rotating body and the second rotating body so that a maximum trajectory of the first rotating body is greater than a maximum trajectory of the second rotating body.

As a result of this configuration, the second rotating body becomes easier to move inward from the first rotating body. For example, the trajectory on which the second rotating body moves can be located inward from the trajectory on which the first rotating body moves. As a result, operation of the second rotating body can be stabilized. For example, derailing of the second rotating body and contacting of the second rotating body with some object can be prevented.

With a moving apparatus according to another aspect of the present disclosure, preferably the control device further includes a first setting unit. The first setting unit is configured to set validity or invalidity of the control that is performed by the first control unit.

As a result of this configuration, the degrees of freedom of the motion of the first rotating body and the second rotating body can be increased.

With a moving apparatus according to another aspect of the present disclosure, preferably the control device includes a second control unit. The second control unit is configured to control a steering angle of at least one of the first rotating body and the second rotating body so that a maximum trajectory of the first rotating body is greater than a maximum trajectory of the second rotating body.

As a result of this configuration, the second rotating body becomes easier to move inward from the first rotating body. For example, the trajectory on which the second rotating body moves can be located inward from the trajectory on which the first rotating body moves. As a result, motion of the second rotating body can be stabilized. For example, derailing of the second rotating body and contacting of the second rotating body with objects can be prevented.

With a moving apparatus according to another aspect of the present disclosure, preferably the control device further includes a second setting unit. The second setting unit is configured to set validity/invalidity of the control that is performed by the second control unit.

As a result of this configuration, the degrees of freedom of the motion of the first rotating body and the second rotating body can be increased.

A moving apparatus according to another aspect of the present disclosure preferably further includes a first sensor. The first sensor is configured to detect an object related to collision to a moving body or a stationary body. In this case, the control device includes a third control unit. The third control unit is configured to control at least one of the first rotating body and the second rotating body so as to avoid the collision when the first sensor detects the object related to the collision. As a result of this configuration, collisions with a moving body or a stationary body can be avoided.

A moving apparatus according to another aspect of the present disclosure preferably further includes a second sensor. The second sensor is configured to detect an object related to derailment of at least one of the first rotating body and the second rotating body. In this case, the control device includes a fourth control unit. The fourth control unit is configured to control at least one of the first rotating body and the second rotating body to avoid the derailment when the second sensor detects the object relate to the derailment. As a result of this configuration, derailing of at least one of the first rotating body and second rotating body can be prevented.

With a moving apparatus according to another aspect of the present disclosure, preferably the first rotating body and the second rotating body are detachably mounted on the main body. As a result of this configuration, the first rotating body and the second rotating body can be easily replaced and repaired.

With a moving apparatus according to another aspect of the present disclosure, preferably the rotating bodies from which the first rotating body and the second rotating body are respectively configured are wheels. The advantageous effects described above can be obtained even with this configuration.

With a moving apparatus according to another aspect of the present disclosure, preferably the rotating bodies from which the first rotating body and the second rotating body are respectively configured are at least one of wheels, ball casters, and crawlers. The advantageous effects described above can be obtained even with this configuration.

According to the present disclosure, the size and the weight of the moving apparatus can be reduced, and the maneuverability of the moving apparatus can be improved.

### BRIEF DESCRIPTION OF THE DRAWINGS

FIG. 1 is a front view of an electric wheelchair adopting a first embodiment of the present disclosure;

FIG. 2A is a side view of the electric wheelchair adopting the first embodiment of the present disclosure;

FIG. 2B is a side view of the electric wheelchair adopting the first embodiment of the present disclosure;

FIG. 3 is a function block diagram of the electric wheelchair adopting the first embodiment of the present disclosure;

FIG. 4 is a diagram explaining control (when turning) of front wheels of the electric wheelchair adopting the first embodiment of the present disclosure;

FIG. 5A is a diagram explaining control (when pivot turning) of the front wheels of the electric wheelchair adopting the first embodiment of the present disclosure;

FIG. 5B is a diagram explaining control of the front wheels of the electric wheelchair adopting the first embodiment of the present disclosure (when pivot turning);

FIG. 6 is a front view of an electric wheelchair adopting a second embodiment of the present disclosure;

FIG. 7A is a side view of the electric wheelchair adopting the second embodiment of the present disclosure;

FIG. 7B is a side view of the electric wheelchair adopting the second embodiment of the present disclosure;

FIG. 8 is a function block diagram of the electric wheelchair adopting the second embodiment of the present disclosure;

FIG. 9 is a diagram explaining control (when turning) of the front wheels of the electric wheelchair adopting the second embodiment of the present disclosure;

FIG. 10A is a diagram explaining control (when pivot turning) of the front wheels of the electric wheelchair adopting the second embodiment of the present disclosure;

FIG. 10B is a diagram explaining control (when pivot turning) of the front wheels of the electric wheelchair adopting the second embodiment of the present disclosure;

FIG. 11A is a drawing illustrating Modification Example 1 of the electric wheelchairs adopting the first and second embodiments of the present disclosure;

FIG. 11B is a drawing illustrating Modification Example 1 of the electric wheelchairs adopting the first and second embodiments of the present disclosure;

FIG. 12 is a drawing illustrating Modification Example 2 of the electric wheelchairs adopting the first and second embodiments of the present disclosure;

FIG. 13A is a drawing illustrating a support member provided in another embodiment;

FIG. 13B is a drawing illustrating a support member provided in another embodiment; and

FIG. 13C is a drawing illustrating a support member provided in another embodiment.

### DETAILED DESCRIPTION OF THE PREFERRED EMBODIMENTS

### First Embodiment

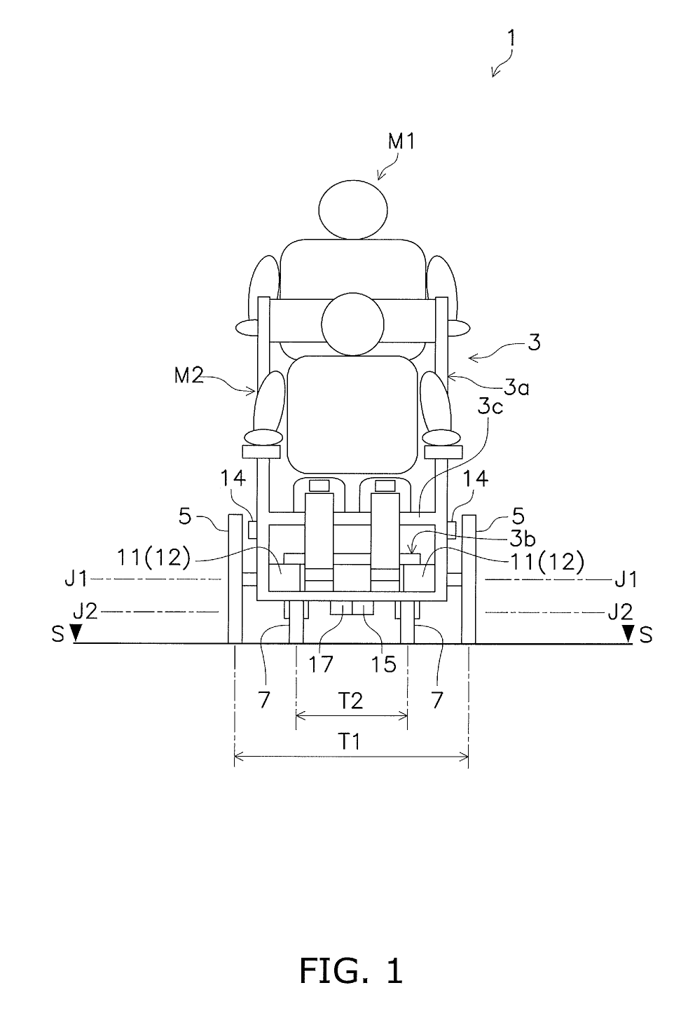

As illustrated in FIG. 1, an electric wheelchair 1 (example of a moving apparatus) adopting a first embodiment of the present disclosure is configured so as to be rideable by a caregiver M1 and movable by a motor 11. Additionally, the electric wheelchair 1 is configured to be capable of moving forward and backward. Furthermore, the electric wheelchair 1 is configured such that the advancing direction and speed is changeable by an operating device 13 (described later).

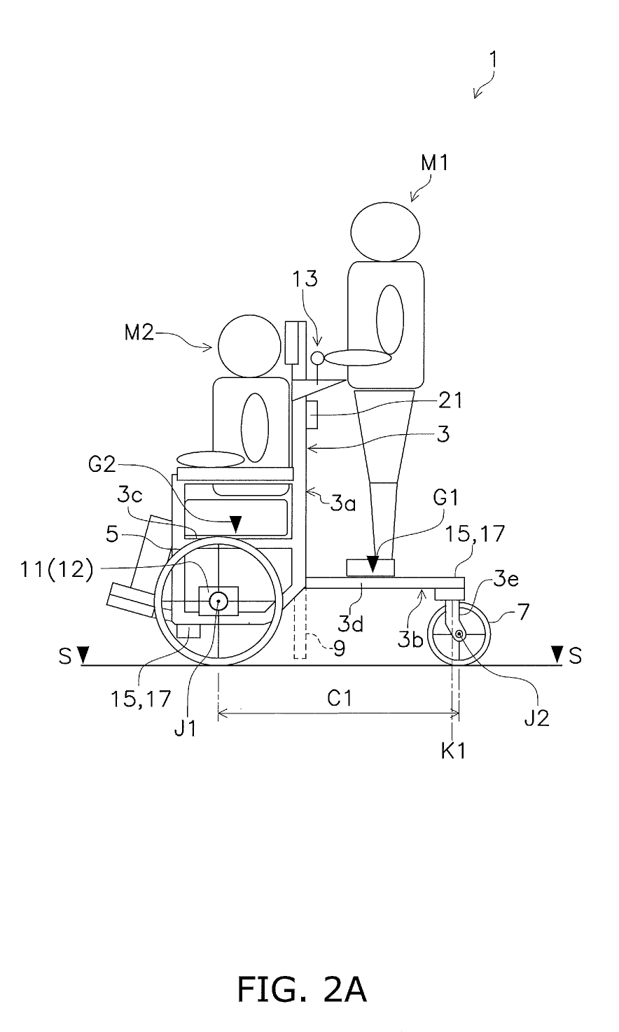

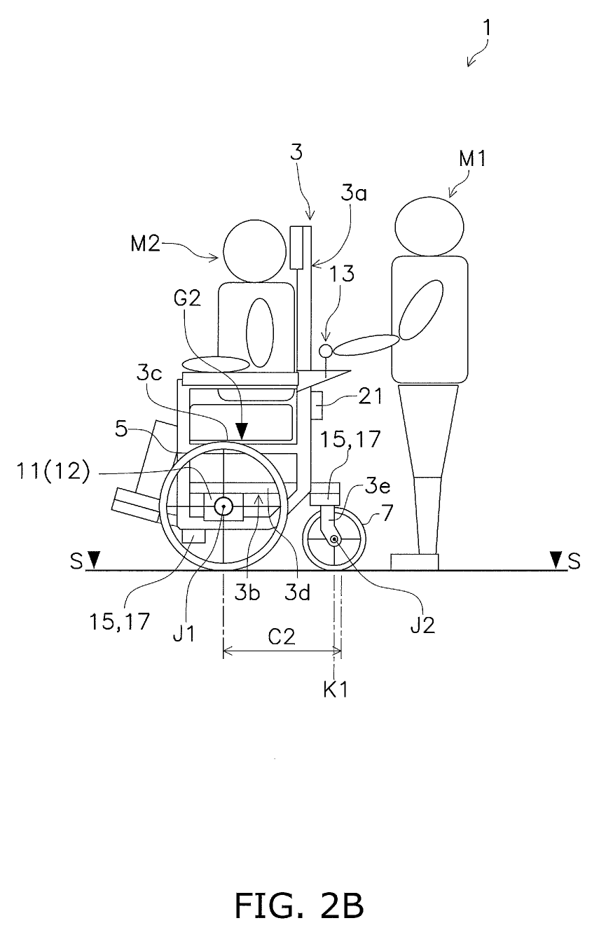

As illustrated in FIG. 1, FIG. 2A, and FIG. 2B, the electric wheelchair 1 includes a main body 3, a pair of front wheels 5 (example of the first rotating body), and a pair of rear wheels 7 (example of the second rotating body). The electric wheelchair 1 further includes a support member 9. The electric wheelchair 1 further includes the motor 11. The electric wheelchair 1 further includes an operating device 13. Moreover, the electric wheelchair 1 includes a plurality of wheelchair speed detection sensors 14. Additionally, the electric wheelchair 1 includes a plurality of object sensors 15 (example of the first sensor), and a plurality of step sensors 17 (example of the second sensor). The electric wheelchair 1 further includes a control device 21.

<Main Body>

As illustrated in FIG. 1, FIG. 2A, and FIG. 2B, the main body 3 is configured so as to be rideable by a care receiver M2 and the caregiver M1 assisting the care receiver M2. Specifically, the main body 3 is configured such that a change between wheelbases C1 and C2 can be performed (see FIG. 2A and FIG. 2B).

The main body 3 is configured such that, when the caregiver M1 and the care receiver M2 are riding on the main body 3, a center of gravity G1 of the caregiver M1 and a center of gravity G2 of the care receiver M2 are positioned within the range of the wheelbase C1.

In other words, the main body 3 is configured such that a point of action S1, at which the mass of the caregiver M1 acts on the main body 3 in the vertical direction, is positioned within the range of the wheelbase C1. Additionally, the main body 3 is configured such that a point of action S2, at which the mass of the care receiver M2 acts on the main body 3 in the vertical direction, is positioned within the range of the wheelbase C1. Note that the points of action S1 and S2 can be interpreted as points where straight lines extending in the vertical direction from the centers of gravity G1 and G2 cross the main body 3.

The main body 3 includes a first frame portion 3a and a second frame portion 3b.

<First Frame Portion>

As illustrated in FIG. 1, FIG. 2A, and FIG. 2B, the first frame portion 3a is configured so as to be rideable by the care receiver M2. A seat portion 3c on which the care receiver M2 can sit is provided on the first frame portion 3a.

<Second Frame Portion>

As illustrated in FIG. 1, FIG. 2A, and FIG. 2B, the second frame portion 3b is configured so as to be rideable by the caregiver M1. The second frame portion 3b is provided with a riding portion 3d where the caregiver M1 can ride.

Note that, in the present embodiment, an example of a case is described in which the caregiver M1 rides while standing on the riding portion 3d, but a configuration is possible in which the caregiver M1 rides while seated on the riding portion 3d. In the latter case, a seat portion for the caregiver M1 is provided on the second frame portion 3b.

As illustrated in FIG. 2A and FIG. 2B, the second frame portion 3b is configured so as to be capable of approaching and moving away from the first frame portion 3a. The change between the wheelbases C1 and C2 is performed by the first frame portion 3a approaching or moving away from the second frame portion 3b.

Specifically, the second frame portion 3b, that is, the riding portion 3d for example, is mounted on the first frame portion 3a so as to be retracted in the first frame portion 3a. Here, the second frame portion 3b, namely the riding portion 3d for example, can be retracted in the first frame portion 3a and pulled out of the first frame portion 3a by sliding along a rail (not illustrated in the drawings) of the first frame portion 3a.

The second frame portion 3b can move between a first posture rideable by the caregiver M1 (see FIG. 2A) and a second posture retracted in the first frame portion 3a (see FIG. 2B). It should be noted that a locking mechanism (not illustrated in the drawings) for holding the second frame portion 3b in the first posture or the second posture is provided between the first frame portion 3a and the second frame portion 3b.

In one example, the wheelbase C1 is largest in the first posture (see FIG. 2A), and the wheelbase C2 is smallest in the second posture (see FIG. 2B). When the locking mechanism is released, as the first posture of the second frame portion 3b is changed into the second posture, the wheelbase C2 decreases. Meanwhile, when the locking mechanism is released, and the second posture of the second frame portion 3b is changed into the first posture, the wheelbase C1 increases.

Here, when the second frame portion 3b is in the first posture, in a state where the caregiver M1 and the care receiver M2 are riding on the electric wheelchair 1, the center of gravity G1 (the point of action S1) of the caregiver M1 and the center of gravity G2 (the point of action S2) of the care receiver M2 are positioned within the range of the wheelbase C1 (see FIG. 2A). When the second frame portion 3b is in the second posture, in a state where the care receiver M2 is seated on the seat portion 3c, the center of gravity G2 (the point of action S2) of the care receiver M2 is positioned within the range of the wheelbase C2 (see FIG. 2B).

Note that, the wheelbases C1 and C2 are each defined by the space between a first rotation axis J1 of the front wheels 5 (described later) and a second rotation axis J2 of the rear wheels 7 (described later). Specifically, the wheelbases C1 and C2 each correspond to the space between the first rotation axis J1 and the second rotation axis J2 in a state where the first rotation axis J1 of the front wheels 5 and the second rotation axis J2 of the rear wheels 7 are substantially parallel to each other.

<Front Wheel>

As illustrated in FIG. 1, FIG. 2A, and FIG. 2B, each of the pair of front wheels 5 is a wheel, for example. The pair of front wheels 5 is mounted on the main body 3, namely the first frame portion 3a for example. Here, each of the pair of front wheels 5 is detachably mounted on the first frame portion 3a. While mounted on the first frame portion 3a, the pair of front wheels 5 contact the ground.

Each of the pair of front wheels 5 has the first rotation axis J1. The wheels of the pair of front wheels 5 are disposed so as to face each other in the direction in which the first rotation axis J1 extends (see FIG. 1). A tread T1 of the front wheels 5 is larger than a tread T2 of the rear wheels 7. The tread T1 of the front wheels 5 is defined by the space between the pair of front wheels 5 in the direction along the first rotation axis J1.

The pair of front wheels 5 is mounted on the main body 3, namely the first frame portion 3a for example, so as to be rotatable around the first rotation axis J1. While mounted, the pair of front wheels 5 can contact a running surface S and rotate.

<Rear Wheel>

As illustrated in FIG. 1, FIG. 2A, and FIG. 2B, each of the pair of rear wheels 7 is a wheel, for example. The pair of rear wheels 7 is mounted on the main body 3, namely the second frame portion 3b for example. Here, the pair of rear wheels 7 is disposed spaced apart from the pair of front wheels 5. Each of the pair of rear wheels 7 is detachably mounted on the second frame portion 3b.

Each of the pair of rear wheels 7 has the second rotation axis J2. The second rotation axis J2 is disposed spaced apart from the first rotation axis J1. Here, the second rotation axis J2 is disposed spaced apart from the first rotation axis J1 in a direction orthogonal to the first rotation axis J1. This orthogonal direction is substantially parallel to the running surface S.

The wheels of the pair of rear wheels 7 are disposed so as to face each other in the direction in which the second rotation axis J2 extends (see FIG. 1). The tread T2 of the rear wheels 7 is smaller than the tread T1 of the front wheels 5. The tread T2 of the rear wheels 7 is defined by the space between the pair of rear wheels 7 in the direction along the second rotation axis J2.

The pair of rear wheels 7 is mounted on the main body 3, namely the second frame portion 3b for example, so as to be rotatable around the second rotation axis J2. While mounted, the pair of rear wheels 7 can contact the running surface S and rotate.

As illustrated in FIG. 2A and FIG. 2B, each of the pair of rear wheels 7 is mounted on the second frame portion 3b so as to be rotatable around a cross axis K1 that crosses the second rotation axis J2. Specifically, a wheel holding member 3e is mounted on the second frame portion 3b so as to be rotatable around the cross axis K1. Additionally, the wheel holding member 3e supports the rear wheels 7 so that each of the rear wheels 7 is capable of rotating around the second rotation axis J2. That is, each of the rear wheels 7 is mounted on the second frame portion 3b so as to be rotatable around the second rotation axis J2 with respect to the wheel holding portion 3e and also so as to be rotatable around the cross axis K1 with respect to the second frame portion 3b.

<Support Member>

As illustrated in FIG. 2A, the support member 9 supports the main body 3 between the first rotation axis J1 and second rotation axis J2 when a change between the wheelbases C1 and C2 is performed. Specifically, the support member 9 is detachably mounted on the main body 3, namely the second frame portion 3b for example. The support member 9 is off from the support member 9 while the electric wheelchair 1 is running and is mounted on the second frame portion 3b while the electric wheelchair 1 is stopped. For example, when a change between the wheelbases C1 and C2 is performed while the electric wheelchair 1 is stopped, the support member 9 is mounted on the second frame portion 3b.

Here, when a change between the wheelbases C1 and C2 is performed, the support member 9 is attached to the second frame portion 3b. In this state, the support member 9 is disposed between the second frame portion 3b and the running surface S so as to be able to contact the running surface S (the ground, for example).

As such, when a change between the wheelbases C1 and C2 is performed, even if the pair of rear wheels 7 lifts from the running surface S (the ground, for example), the pair of front wheels 5 and the support member 9 can support the second frame portion 3b. Meanwhile, while the electric wheelchair 1 is running, the support member 9 is off from the second frame portion 3b. In this state, the pair of front wheels 5 and the pair of rear wheels 7 can contact the running surface S (the ground, for example) and rotate.

Note that, in cases where a predetermined space is provided between the support member 9 and the running surface S (the ground, for example) while the pair of front wheels 5 and the pair of rear wheels 7 are in contact with the ground, the electric wheelchair 1 is able to run with the support member 9 mounted on the main body 3.

<Motor>

As illustrated in FIG. 1, FIG. 2A, and FIG. 2B, the motor 11 drives the pair of front wheels 5. In one example, the motor 11 is configured from a pair of electric motors 12. The pair of electric motors 12 drive the pair of front wheels 5 respectively. Each of the pair of electric motors 12 is mounted on the main body 3, namely the first frame portion 3a for example. Each of the pair of electric motors 12 receives a supply of power from a power source (not illustrated in the drawings) to operate. Each of the front wheels 5 are independently driven by the operation of each electric motor 12. In other words, in the present embodiment, the electric wheelchair 1 is a front wheel drive wheelchair. Note that, the power source is mounted on the main body 3, namely the first frame portion 3a for example.

<Operating Device>

The operating device 13 is used to operate the electric wheelchair 1. In one example, the operating device 13 is configured from a lever member such as a joystick, as illustrated in FIG. 2A and FIG. 2B. The operating device 13 is mounted on the main body 3, namely the second frame portion 3b for example. Here, the operating device 13 is mounted on a rear portion of the second frame portion 3b. When the operating device 13 is operated by the caregiver M1, a signal corresponding to the operation of the operating device 13 is sent to the control device 21.

An example of a case has been described in which the operating device 13 is operated by the caregiver M1, but a configuration is possible in which, in addition to the operating device 13 for the caregiver M1, an operating device (not illustrated in the drawings) that is operable by the care receiver M2 can be provided on the main body 3, namely the first frame portion 3a for example, for the care receiver M2.

<Wheelchair Speed Detection Sensors>

The plurality (two, for example) of wheelchair speed detection sensors 14 is for detecting the speed of the electric wheelchair 1. As illustrated in FIG. 1, the plurality of wheelchair speed detection sensors 14 are mounted on the main body 3. Here, the wheelchair speed detection sensors 14 are mounted on the first frame portion 3a so as to face the front wheels 5 respectively. The wheelchair speed detection sensors 14 operate upon receipt of a supply of power from the power source and detect the number of rotations of the front wheels 5. Signals corresponding to the rotation speed of the front wheels 5 are sent to the control device 21.

<Object Sensors>

As illustrated in FIG. 1, FIG. 2A, and FIG. 2B, the plurality (two, for example) of object sensors 15 detect collisions with moving bodies and/or stationary bodies. The plurality of object sensors 15 are mounted on the main body 3. In this embodiment, one of the object sensors 15 is mounted on the front portion of the first frame portion 3a. Another one of the object sensors 15 is mounted on the rear portion of the second frame portion 3b.

The object sensors 15 operate upon receipt of a power supply from the power source and detect distances to moving bodies and/or stationary bodies. Signals corresponding to the distances to the moving bodies and/or stationary bodies are sent to the control device 21.

<Step Sensors>

As illustrated in FIG. 1, FIG. 2A, and FIG. 2B, the plurality (two, for example) of step sensors 17 detect derailing of the front wheels 5 and derailing of the rear wheels 7. The plurality of step sensors 17 are mounted on the main body 3. In this embodiment, one of the step sensors 17 is mounted on the bottom side of the first frame portion 3a, between the seat portion 3c and the first rotation axis J1. Another of the step sensors 17 is mounted on the bottom side of the second frame portion 3b, between the riding portion 3d and the second rotation axis J2.

The step sensors 17 operate upon receipt of a power supply from the power source to operate and detect information of the running surface S (the ground, for example) in front of the front wheels 5 or information of the running surface S (the ground, for example) behind the rear wheels 7. Signals to identify the information of the running surface S in front of and behind the main body 3 are sent to the control device 21.

<Control Device>

As illustrated in FIG. 2A and FIG. 2B, the control device 21 is mounted on the main body 3, namely the first frame portion 3a for example. The control device 21 is configured to be capable of controlling the pair of front wheels 5. The control device 21 receives the signals from the operating device 13, the wheelchair speed detection sensors 14, the object sensors 15, and the step sensors 17 and sends control signals to the pair of electric motors 12. Then, each of the electric motors 12 is actuated on the basis of these control signals and the pair of front wheels are respectively driven by the pair of electric motors 12.

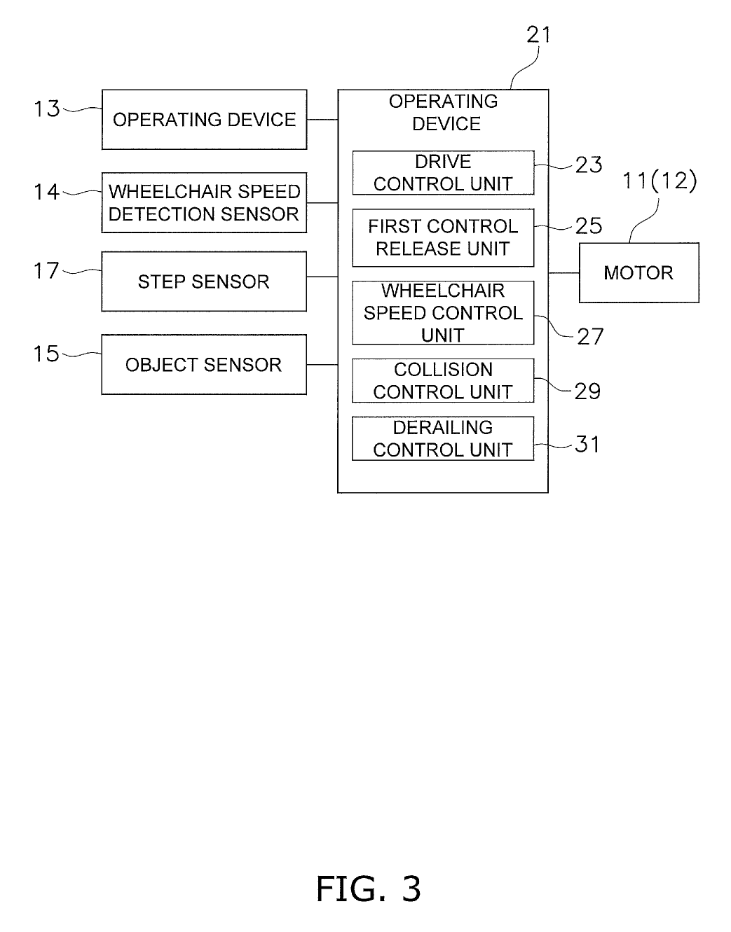

As illustrated in FIG. 3, the control device 21 includes a drive control unit 23 (example of the first control unit), a first control release unit 25 (example of the first setting unit), a wheelchair speed control unit 27 (example of the second control unit), a collision control unit 29 (example of the third control unit), and a derailing control unit 31 (example of the fourth control unit).

(Drive Control Unit)

The drive control unit 23 illustrated in FIG. 3 controls the pair of electric motors 12 on the basis of the signals from the operating device 13. For example, the drive control unit 23 controls the electric motors 12 so that, when the caregiver M1 pushes the operating device 13 forward, the electric wheelchair 1 advances. Meanwhile, the drive control unit 23 controls the electric motors 12 so that, when the caregiver M1 pulls the operating device 13 backward, the electric wheelchair 1 retreats.

The drive control unit 23 controls the electric motors 12 so that, when the caregiver M1 pushes the operating device 13 diagonally forward, the electric wheelchair 1 advances diagonally forward. Meanwhile, the drive control unit 23 controls the electric motors 12 so that, when the caregiver M1 pulls the operating device 13 diagonally backward, the electric wheelchair 1 goes diagonally backward. Furthermore, the drive control unit 23 controls the electric motors 12 so that, when the caregiver M1 pushes the operating device 13 sideways, the electric wheelchair 1 to perform a pivot turn.

In this way, the drive control unit 23 controls the electric motors 12 according to the operation direction of the operating device 13. Then, the front wheels 5 are respectively driven by the electric motors 12.

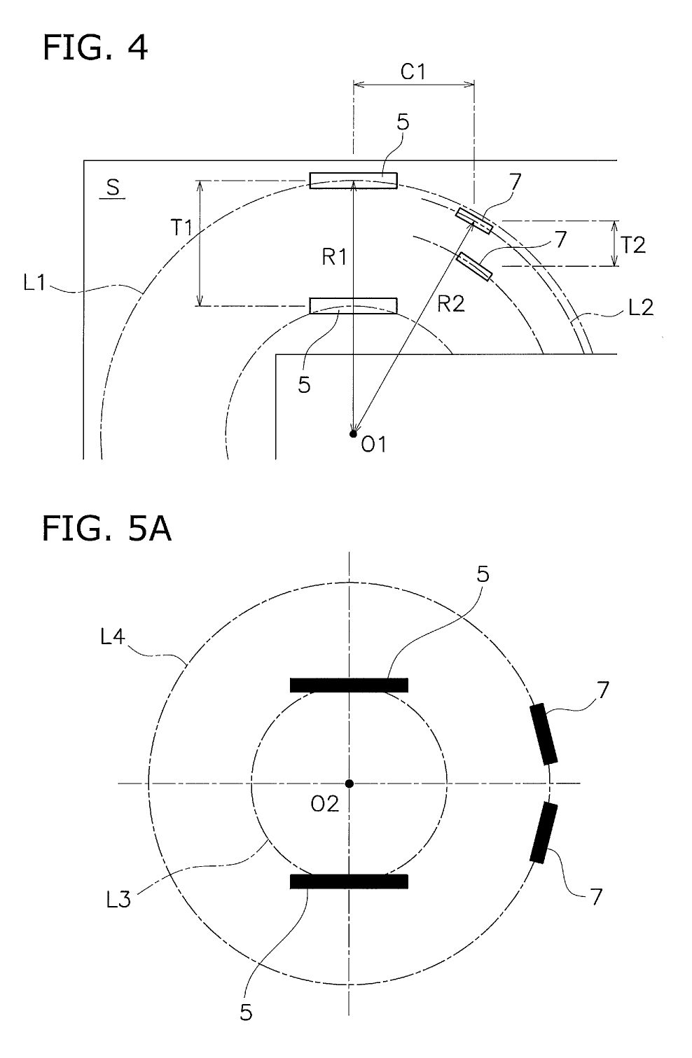

As described above, when the caregiver M1 pushes the operating device 13 diagonally forward, the electric wheelchair 1 advances to the right or to the left. In this case, as illustrated in FIG. 4, the drive control unit 23 controls the rotation speed of each of the electric motors 12 so that a maximum trajectory L1 of the pair of front wheels 5 is greater than a maximum trajectory L2 of the pair of rear wheels 7, with a predetermined point O1 as a reference.

For example, when the electric wheelchair 1 turns on a left turn path S (see FIG. 4), the drive control unit 23 controls the rotation speed of each of the electric motors 12 so that a first turning radius R1 of an outside wheel of the pair of front wheels 5 is greater than a second turning radius R2 of an outside wheel of the pair of rear wheels 7, with a first turning center O1 as a reference. The drive control unit 23 controls the rotation speed of the electric motors 12 in this manner, thereby controlling the rotation speed of each of the pair of front wheels 5.

In this case, the drive control unit 23 sets a rotation speed difference between the rotation speed of the electric motor 12 driving the outside wheel of the front wheels 5 and the rotation speed of the electric motor 12 driving the inside wheel of the front wheels 5 so that the first turning radius R1 is greater than the second turning radius R2. That is, the drive control unit 23 sets the rotation speed difference between the rotation speed of the outside wheel of the front wheels 5 and the rotation speed of the inside wheel of the front wheels 5 via the electric motors 12. As a result, the outside wheel of the rear wheels 7 is no longer positioned outward from the outside wheel of the front wheels 5 and, therefore, the electric wheelchair 1 can suitably run, even in situations such as when the running path is narrow.

Note that, when the operating device 13 is pulled diagonally backward, the drive control unit 23 sets the rotation speed of each of the electric motors 12 and controls the rotation speed of each of the pair of front wheels 5 so that the maximum trajectory L1 (R1) of the pair of front wheels 5 is greater than the maximum trajectory L2 (R2) of the pair of rear wheels 7, with the first turning center O1 as a reference.

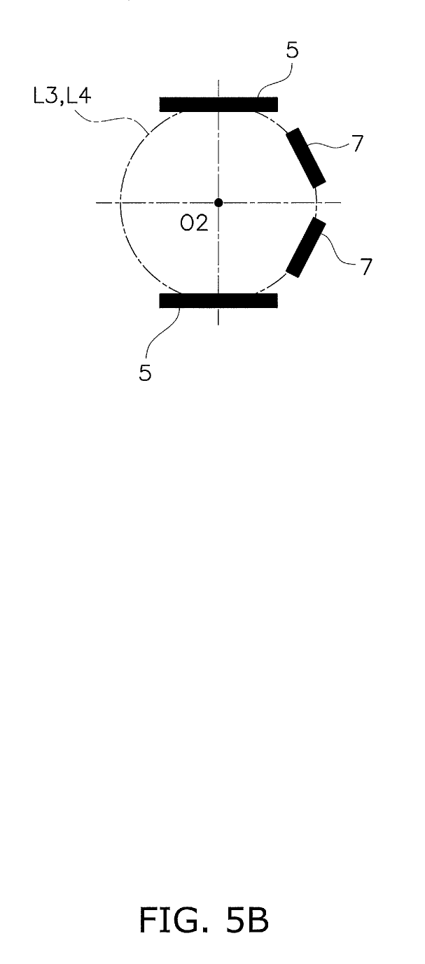

As described above, when the caregiver M1 pushes the operating device 13 sideways, the electric wheelchair 1 performs a pivot turn, as illustrated in FIG. 5. In this case, the drive control unit 23 controls the rotation speed of each of the electric motors 12 so that a trajectory L3 of one of the front wheels 5 and the trajectory L3 of the other of the front wheels 5 are the same, with a predetermined point O2 as a reference. The drive control unit 23 controls the rotation speed of the electric motors 12 in this manner, thereby controlling the rotation speed of each of the pair of front wheels 5.

For example, when pivot turning the electric wheelchair 1 as illustrated in FIG. 5A and FIG. 5B, the drive control unit 23 controls the pair of front wheels 5 so that the outside wheel of the pair of front wheels 5 and the inside wheel of the pair of front wheels 5 rotate at the same speed in opposite directions, with a second turning center O2 as a reference. As a result, the pair of front wheels 5 and the pair of rear wheels 7 will form the circular trajectories L3 and L4, with the second turning center O2 as a reference, and the orientation of the electric wheelchair 1 can be suitably changed.

FIG. 5A is a diagram illustrating a case in which the second frame portion 3b is in the first posture, and FIG. 5B is a diagram illustrating a case in which the second frame portion 3b is in the second posture. The second turning center O2 corresponds to the center point on the first rotation axis J1 between the pair of front wheels 5.

(First Control Release Unit)

The first control release unit 25 is capable of enabling or disabling control by the drive control unit 23. Specifically, operating an operation panel (not illustrated in the drawings) allows the first control release unit 25 to partially enable or disable the control by the drive control unit 23. For example, the electric wheelchair 1 can be suitably run in situations such as when the running path is wide by operating the operation panel to disable the control to make the maximum trajectory of the pair of front wheels 5 greater than the maximum trajectory of the pair of rear wheels 7.

(Wheelchair Speed Control Unit)

The wheelchair speed control unit 27 illustrated in FIG. 3 controls the pair of electric motors 12 on the basis of the signals from the wheelchair speed detection sensors 14. For example, the wheelchair speed control unit 27 calculates the rotation speed on the basis of the rotation number detected by the wheelchair speed detection sensors 14. Note that the time information used to calculate the rotation speed can be acquired from the wheelchair speed detection sensors 14 or can be calculated by the wheelchair speed control unit 27.

Then, the wheelchair speed control unit 27 determines whether the rotation speed is less than a predetermined rotation speed or not. In cases where the rotation speed is greater than or equal to the predetermined rotation speed, the wheelchair speed control unit 27 issues commands to the pair of electric motors 12 to reduce the rotation speed to less than the predetermined rotation speed. As a result, the speed of the electric wheelchair 1 can be restricted from becoming excessively fast.

(Collision Control Unit)

The collision control unit 29 illustrated in FIG. 3 controls the pair of electric motors 12 to avoid collision when at least one of the plurality of object sensors 15 detects an object related to collision.

For example, the collision control unit 29 calculates an object distance between the main body 3 and a moving body and/or stationary body on the basis of the signals from the object sensors 15. The collision control unit 29 then determines whether the object distance is less than a predetermined distance or not. In cases where the object distance is less than the predetermined distance, the collision control unit 29 issues commands to the pair of electric motors 12 to stop the rotation of the pair of front wheels 5. As a result, the electric wheelchair 1 can be restricted from colliding with moving bodies and/or stationary bodies.

(Derailing Control Unit)

The derailing control unit 31 illustrated in FIG. 3 controls the pair of electric motors 12 to avoid derailing when the step sensors 17 detect an object related to derailment.

For example, the derailing control unit 31 identifies information of the running surface S in the advancing direction of the main body 3 on the basis of the signals from the step sensors 17. The derailing control unit 31 then determines whether there is a step in the running surface S or not. In cases where it is determined that there is a step in the running surface S, the derailing control unit 31 issues commands to the pair of electric motors 12 to stop the rotation of the pair of front wheels 5. As a result, the electric wheelchair 1 can avoid situations such as derailing due to steps and colliding with steps.

The electric wheelchair 1 configured as described above includes the main body 3, the pair of front wheels 5, and the pair of rear wheels 7. The pair of front wheels 5 is mounted on the main body 3 so as to be rotatable around the first rotation axis J1. The pair of rear wheels 7 is mounted on the main body 3 so as to be rotatable around the second rotation axis J2. In this embodiment, the pair of front wheels 5 and the pair of rear wheels 7 contact the ground. The main body 3 is configured such that a changed between the wheelbases C1 and C2 defined by the first rotation axis J1 and second rotation axis J2 can be performed. Due to this configuration, the size and the weight of the electric wheelchair 1 can be reduced and the maneuverability can be improved.

### Second Embodiment

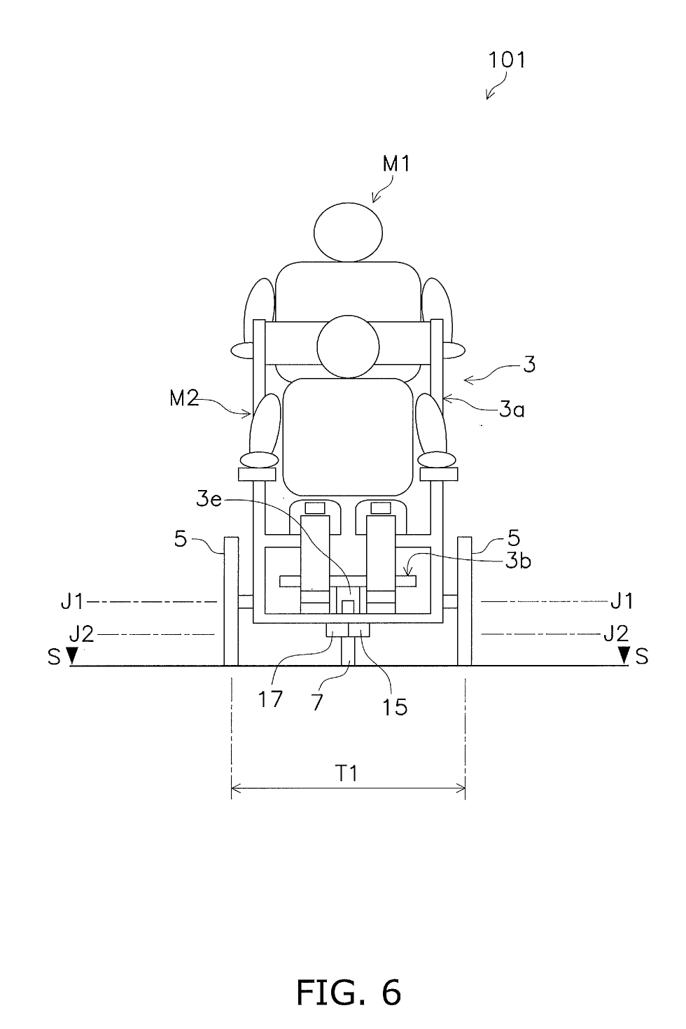

As illustrated in FIG. 6, an electric wheelchair 101 (example of the moving apparatus) adopting a second embodiment of the present disclosure is configured so as to be rideable by a caregiver M1 and operable by a motor 11. Additionally, the electric wheelchair 101 is configured to be capable of moving forward and backward. Furthermore, the electric wheelchair 101 is configured such that the advancing direction and speed can be changed by an operating device 13

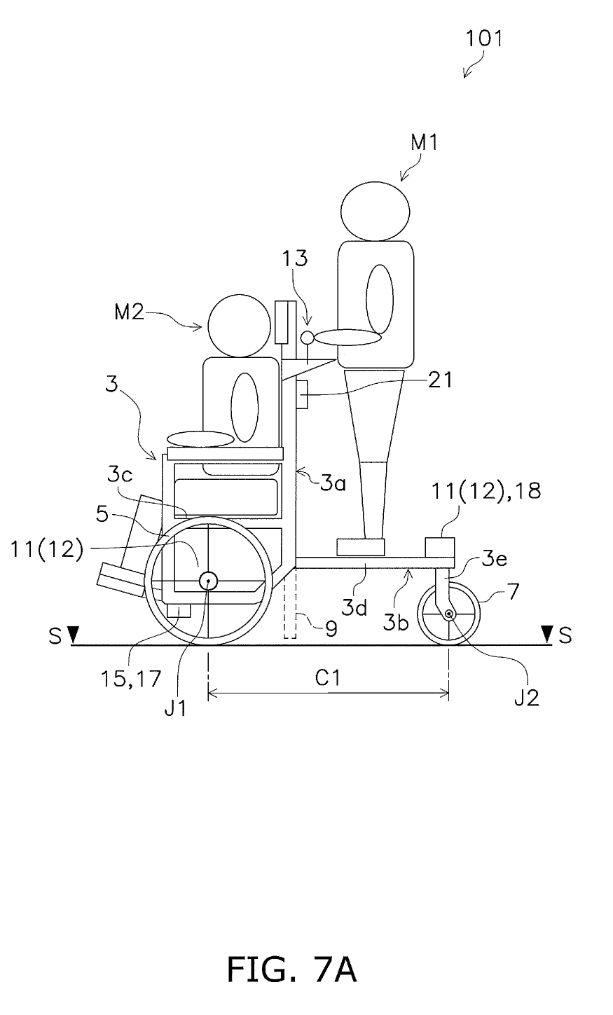

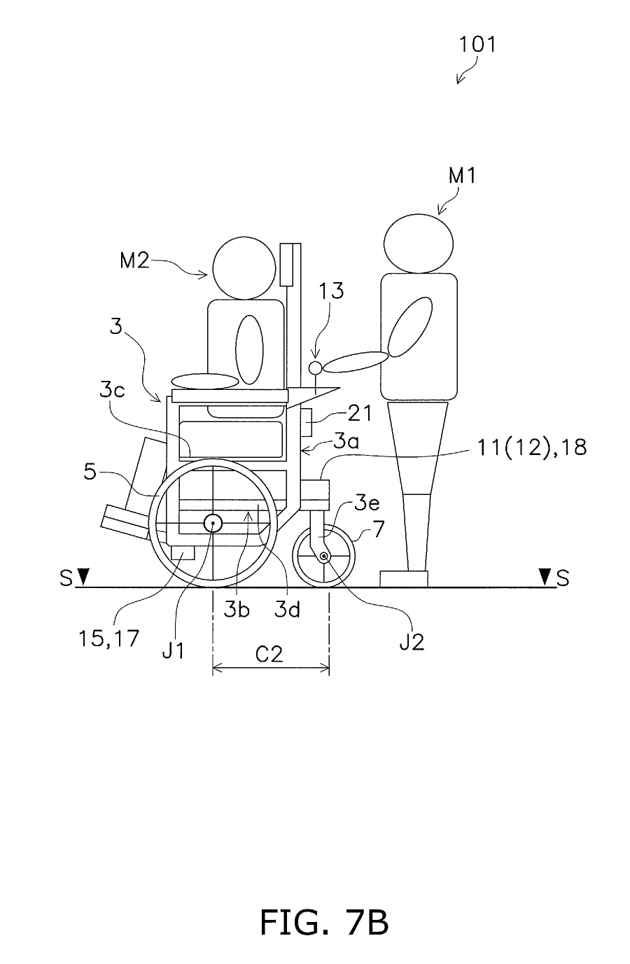

As illustrated in FIG. 6, FIG. 7A, and FIG. 7B, in the second embodiment, the electric wheelchair 101 includes a main body 3, a pair of front wheels 5 (example of the first rotating body), and a rear wheel 7 (example of the second rotating body). The electric wheelchair 101 further includes a support member 9. Additionally, the electric wheelchair 101 further includes the motor 11. The electric wheelchair 101 further includes an operating device 13. Additionally, the electric wheelchair 101 includes a plurality of object sensors 15 and a plurality of step sensors 17. The electric wheelchair 101 further includes a steering device 18. The electric wheelchair 101 further includes a control device 21.

The components of the second embodiment are substantially the same as the components of the first embodiment, with the exception of the rear wheel 7, the motor 11, the steering device 18, and the control device 21. As such, in the second embodiment, descriptions are foregone for the components that are substantially the same as in the first embodiment. The components for which description is forgone are configured as described in the first embodiment.

<Rear Wheel>

As illustrated in FIG. 6, FIG. 7A, and FIG. 7B, the rear wheel 7 is a wheel, for example. The rear wheel 7 is mounted on the main body 3, namely the second frame portion 3b for example. Here, the rear wheel 7 is disposed spaced apart from the pair of front wheels 5. The rear wheel 7 is detachably mounted on the second frame portion 3b.

Specifically, the rear wheel 7 has the second rotation axis J2. The second rotation axis J2 is disposed spaced apart from the first rotation axis J1. Here, the second rotation axis J2 is disposed spaced apart from the first rotation axis J1 in a direction orthogonal to the first rotation axis J1. This orthogonal direction is substantially parallel to the running surface S. In this state, the rear wheel 7 is mounted on the main body 3, namely the second frame portion 3b for example, so as to be rotatable around the second rotation axis J2. The rear wheel 7 can contact the running surface S and rotate.

The rear wheel 7 is mounted on the second frame portion 3b so as to be rotatable around a cross axis K1 that crosses the second rotation axis J2. Specifically, a wheel holding member 3e is mounted on the second frame portion 3b so as to be rotatable around the cross axis K1. Additionally, the wheel holding member 3e supports the rear wheel 7 so as to be rotatable around the second rotation axis J2. That is, the rear wheel 7 is mounted on the second frame portion 3b so as to be rotatable around the second rotation axis J2 with respect to the wheel holding member 3e and also capable of rotating around the cross axis K1 with respect to the second frame portion 3b.

<Motor>

The motor 11 drives the rear wheel 7. In one example, the motor 11 is an electric motor 12. The electric motor 12 drives the rear wheel 7. As illustrated in FIG. 7A and FIG. 7B, the electric motor 12 is mounted on the main body 3, namely the second frame portion 3b for example. The electric motor 12 receives a supply of power from a power source (not illustrated in the drawings) to operate. The rear wheel 7 is driven by the operation of the electric motor 12. In other words, in the present embodiment, the electric wheelchair 101 is a rear wheel drive wheelchair.

<Steering Device>

The steering device 18 is used to set a steering angle of the rear wheel 7. The steering device 18 sets a steering angle of the rear wheel 7 by rotating the rear wheel 7 around the cross axis K1 described above. That is, the advancing direction of the electric wheelchair 101 is determined by the steering device 18 setting the steering angle of the rear wheel 7.

As illustrated in FIG. 7A and FIG. 7B, the steering device 18 is mounted on the main body 3, namely the second frame portion 3b for example. In one example, the steering device 18 rotates the rear wheel 7, namely the wheel holding member 3e for example, around the cross axis K1 with respect to the second frame portion 3b, according to the operation direction of the operating device 13. As a result, the steering angle of the rear wheel 7 is set and the advancing direction of the electric wheelchair 101 is determined.

<Control Device>

The control device 21 is configured to be capable of controlling the rear wheel 7. The control device 21 receives signals from the operating device 13, the wheelchair speed detection sensors 14, the object sensors 15, the step sensors 17, and a steering angle sensor and sends a control signal to the electric motor 12. The electric motor 12 is then actuated on the basis of this control signal and the rear wheel 7 is driven by the electric motor 12.

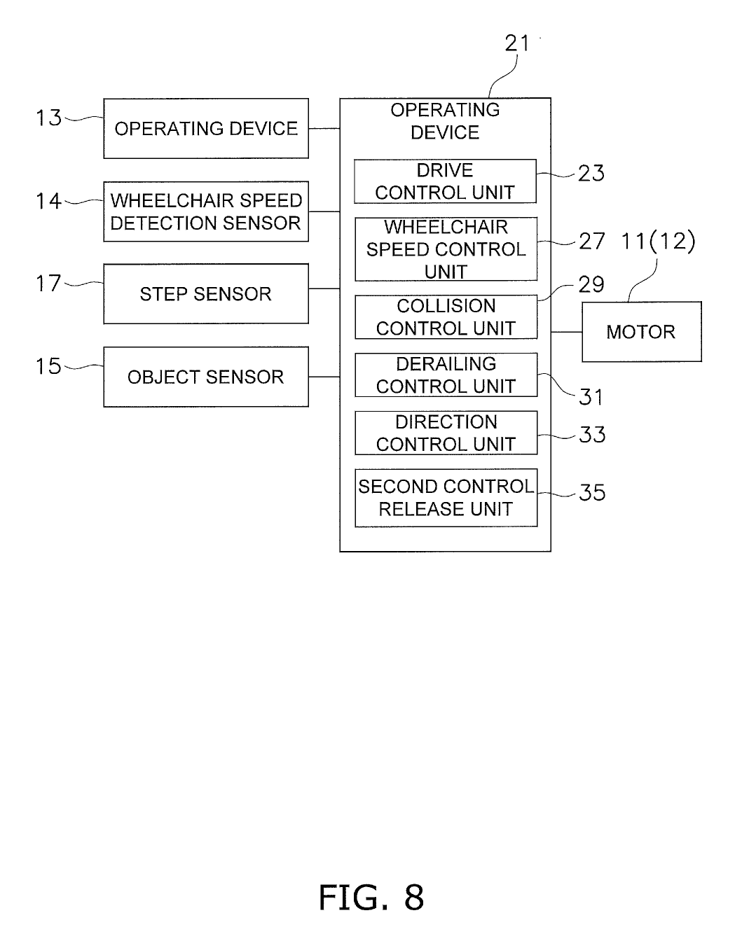

As illustrated in FIG. 8, the control device 21 includes a drive control unit 23, a wheelchair speed control unit 27, a collision control unit 29, a derailing control unit 31, a direction control unit 33 (example of the second control unit), and a second control release unit 35 (example of the second setting unit).

The control device 21 of the first embodiment controls the electric motors 12 to drive the front wheels 5. In contrast, the control device 21 of the second embodiment controls the electric motor 12 to drive the rear wheel 7. Thus, with the exception of the target element that the electric motor 12 drives, the configurations of the wheelchair speed control unit 27, the collision control unit 29, and the derailing control unit 31 in the second embodiment are substantially the same as in the first embodiment. As such, in this specification, descriptions for the components that have substantially the same configurations as in the first embodiment are forgone and only the components that have configurations that differ from the first embodiment are described.

(Drive Control Unit)

The drive control unit 23 illustrated in FIG. 8 controls the electric motor 12 on the basis of the signals from the operating device 13. For example, the drive control unit 23 controls the electric motor 12 so that, when the caregiver M1 pushes the operating device 13 forward or diagonally forward, the electric wheelchair 101 advances. Meanwhile, the drive control unit 23 controls the electric motor 12 so that, when the caregiver M1 pulls the operating device 13 backward or diagonally backward, the electric wheelchair 101 retreats.

(Direction Control Unit)

The direction control unit 33 illustrated in FIG. 8 controls the steering device 18 on the basis of the signals from the operating device 13. For example, the direction control unit 33 controls the steering device 18 so that, when the caregiver M1 pushes or pulls the operating device 13 forward or backward, the electric wheelchair 101 advances or retreats. In this case, the steering device 18 sets the steering angle of the rear wheel 7, namely the wheel holding member 3e for example, so that the second rotation axis J2 is substantially parallel to the first rotation axis J1. Specifically, the steering device 18 sets the rear wheel 7, namely the wheel holding member 3e for example, so that the second rotation axis J2 is substantially parallel to the first rotation axis J1, and also the second rotation axis J2 is substantially parallel to the running surface S.

When the caregiver M1 pushes or pulls the operating device 13 diagonally forward or diagonally backward, the direction control unit 33 controls the steering device 18 so that the electric wheelchair 101 diagonally advances or diagonally retreats. In this case, the steering device 18 sets the rear wheel 7, namely the wheel holding member 3e for example, so that the second rotation axis J2 is inclined with respect to the first rotation axis J1. Specifically, the steering device 18 sets the rear wheel 7, namely the wheel holding member 3e for example, so that the second rotation axis J2 is inclined with respect to the first rotation axis J1, and also the second rotation axis J2 is substantially parallel to the running surface S.

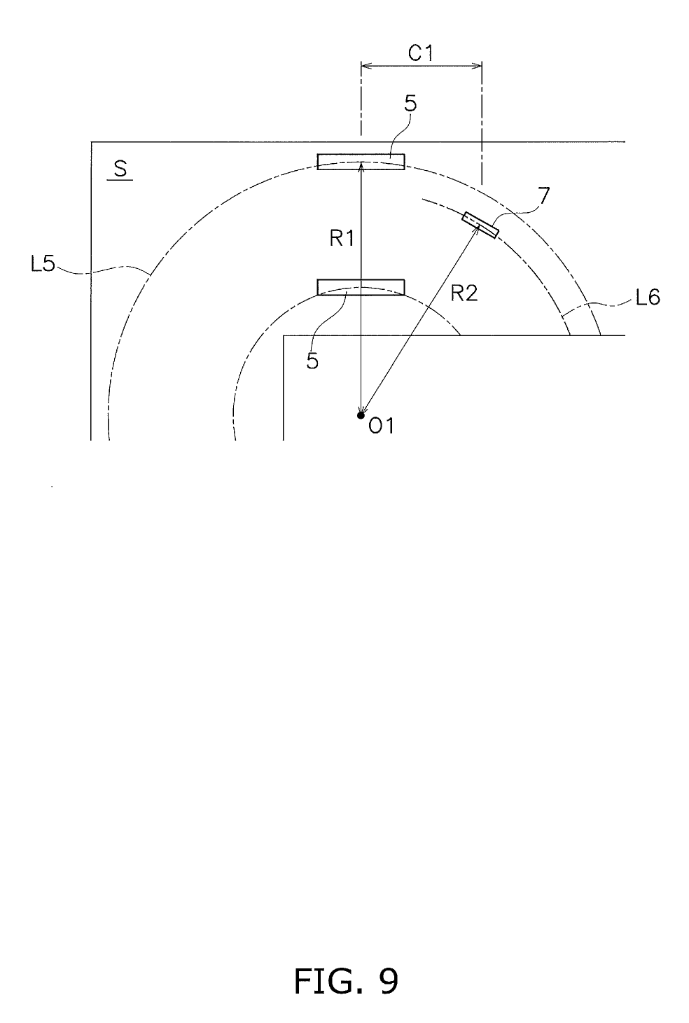

Here, when the caregiver M1 pushes or pulls the operating device 13 diagonally forward or diagonally backward, the direction control unit 33 controls the steering angle of the rear wheel 7 so that a maximum trajectory L6 of the rear wheel 7 is less than a maximum trajectory L5 of the pair of front wheels 5, as illustrated in FIG. 9.

In this case, the direction control unit 33 controls the steering device 18 so that the maximum trajectory L6 of the rear wheel 7 is less than the maximum trajectory L5 of the pair of front wheels 5, with a predetermined point O1 as a reference. For example, when the electric wheelchair 101 turns on a left turn path (see FIG. 9), the direction control unit 33 controls the steering device 18 so that a second turning radius R2 of the rear wheel 7 is less than a first turning radius R1 of the outside wheel of the pair of front wheels 5, with a first turning center O1 as a reference.

Thus, the direction control unit 33 controls the steering angle of the rear wheel 7 (the wheel holding member 3e) via the steering device 18. As a result, the rear wheel 7 is no longer positioned outward from the outside wheel of the front wheels 5 and, therefore, the electric wheelchair 101 can suitably run, even in situations such as when the running path is narrow.

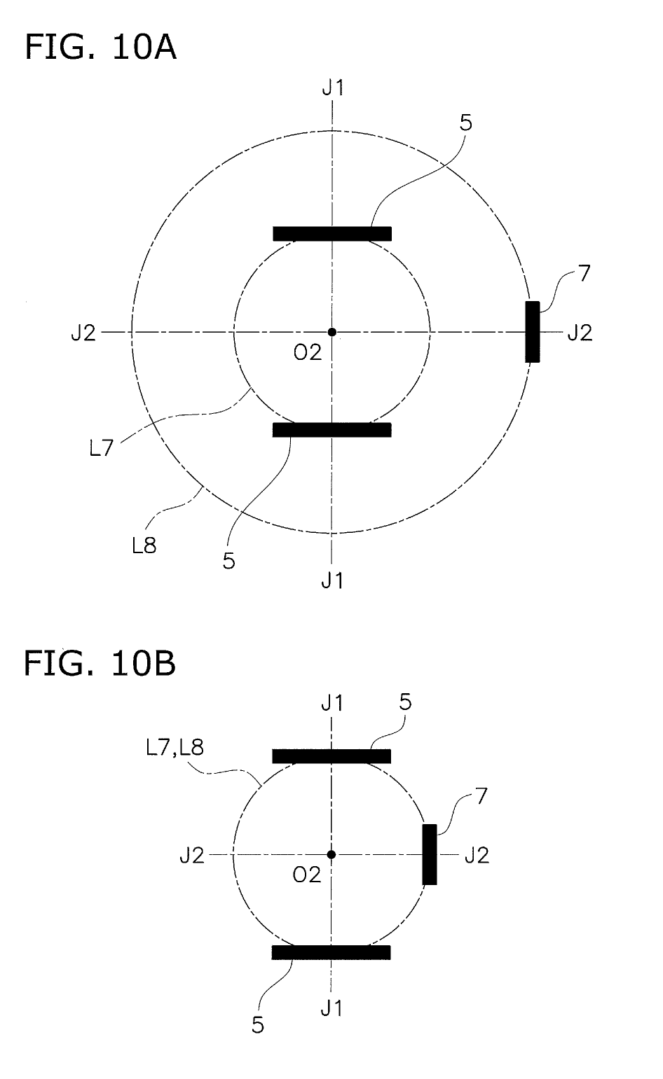

Furthermore, when the caregiver M1 pushes the operating device 13 sideways, the direction control unit 33 controls the steering angle of the rear wheel 7 such that the electric wheelchair 101 performs a pivot turn (see FIG. 10A and FIG. 10B). Specifically, the direction control unit 33 controls the steering device 18 so that a trajectory L7 of one of the front wheels 5 and the trajectory L7 of the other of the front wheels 5 are the same, with a predetermined point O2 as a reference.

For example, when pivot turning the electric wheelchair 101 as illustrated in FIG. 10A and FIG. 10B, the direction control unit 33 controls the steering device 18 so that the trajectory L7 of one of the front wheels 5 and the trajectory L7 of the other of the front wheels 5 are the same, with a second turning center O2 as a reference. In this case, the direction control unit 33 controls the steering device 18 so that a trajectory L8 of the rear wheel 7 is similar to the trajectories of the pair of front wheels 5.

In other words, the direction control unit 33 controls the steering device 18 so that the second rotation axis J2 passes through the second turning center O2. As a result, the pair of front wheels 5 and the rear wheel 7 will form circular trajectories L7 and L8, with the second turning center O2 as a reference, and the orientation of the electric wheelchair 101 can be suitably changed.

FIG. 10A is a diagram illustrating a case in which the second frame portion 3b is in the first posture, and FIG. 10B is a diagram illustrating a case in which the second frame portion 3b is in the second posture. The second turning center O2 corresponds to the center point on the first rotation axis J1 between the pair of front wheels 5.

(Second Control Release Unit)

The second control release unit 35 is capable of enabling or disabling control by the direction control unit 33. Specifically, operating an operation panel (not illustrated in the drawings) allows the second control release unit 35 to partially enable or disable the control of the direction control unit 33. For example, the electric wheelchair 101 can be suitably run in situations such as when the running path is wide by operating the operation panel to disable the control to make the maximum trajectory of the rear wheel 7 less than the maximum trajectory of the pair of front wheels 5.

### Modification Example 1

In the first and second embodiments, examples are described where the second frame portion 3b is retracted in the first frame portion 3a. However, in Modification Example 1, an example of a case is described in which the second frame portion 3b is folded toward the first frame portion 3a.

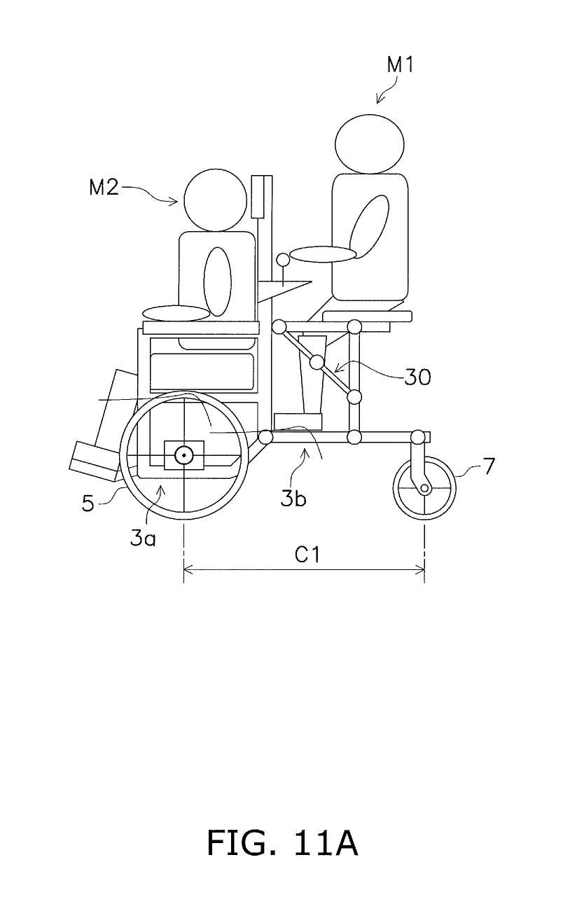

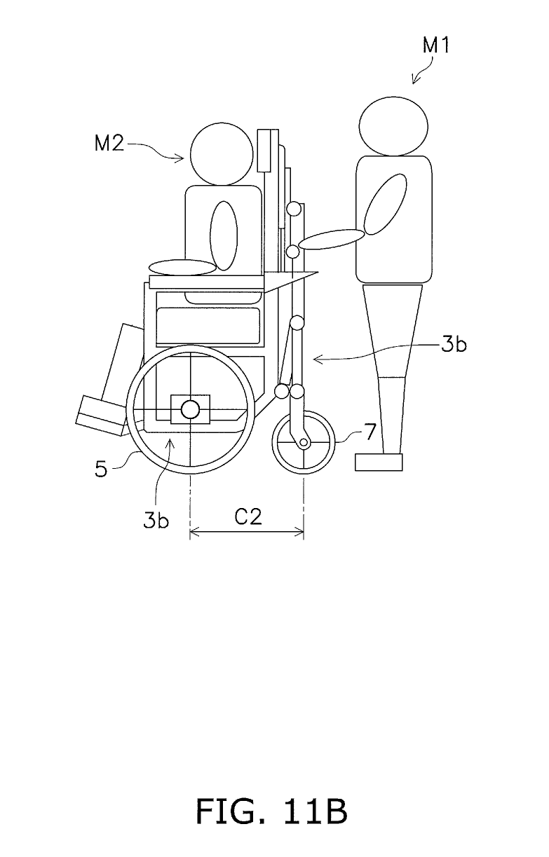

For example, as illustrated in FIG. 11A and FIG. 11B, the second frame portion 3b is configured from an articulated frame. The joints are depicted as white circles. A locking mechanism 30 for holding the second frame portion 3b in the first posture is provided between the first frame portion 3a and the second frame portion 3b.

In this case, the wheelbases C1 and C2 can be changed between a state illustrated in FIG. 11A in which the second frame portion 3b is expanded (the first posture that allows the caregiver M1 to ride), and a state illustrated in FIG. 11B in which the second frame portion 3b is folded (the second posture that does not allow the caregiver M1 to ride).

### Modification Example 2

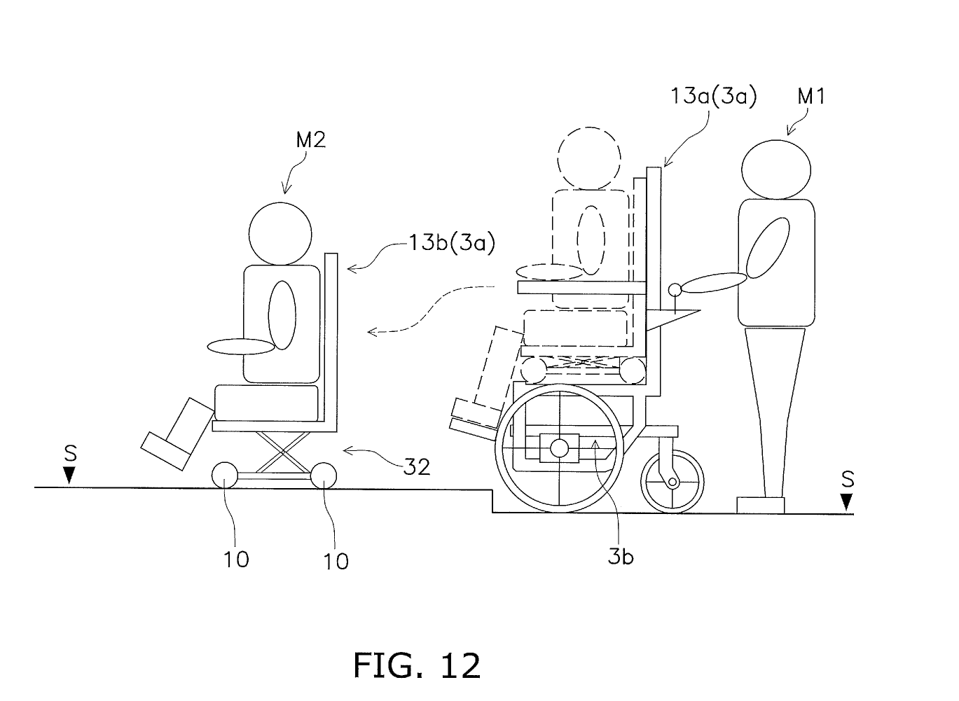

In Modification Example 2, the first frame portion 3a includes a main frame portion 13a and a riding frame portion 13b, as illustrated in FIG. 12. In this case, the main frame portion 13a is connected to the second frame portion 3b. The caregiver M2 can ride on the riding frame portion 13b. The riding frame portion 13b is detachably mounted on the main frame portion 13a.

A plurality (four, for example) of wheels 10 (example of the third rotating body) are mounted on the riding frame portion 13b. Specifically, the plurality of wheels 10 are mounted on the riding frame portion 13b via a stretcher structure 32. In this case, the riding frame portion 13b is accommodated in the main frame portion 13a by folding the stretcher structure 32. Meanwhile, the riding frame portion 13b is detached from the main frame portion 13a by expanding the stretcher structure 32, and is capable of independently running.

### Other Embodiments

(a) In the first embodiment described above, the number of the front wheels 5 can be set to three or more, and the number of the rear wheels 7 can be set to one or three or more.

(b) In the second embodiment described above, the number of the front wheels 5 can be set to one or three or more, and the number of the rear wheel 7 can be set to two or more.

(c) In the first and second embodiments, examples are described where the support member 9 is mounted on the main body 3. However, any configuration can be implemented, provided that the support member 9 can support the main body 3 between the first rotation axis J1 and second rotation axis J2.

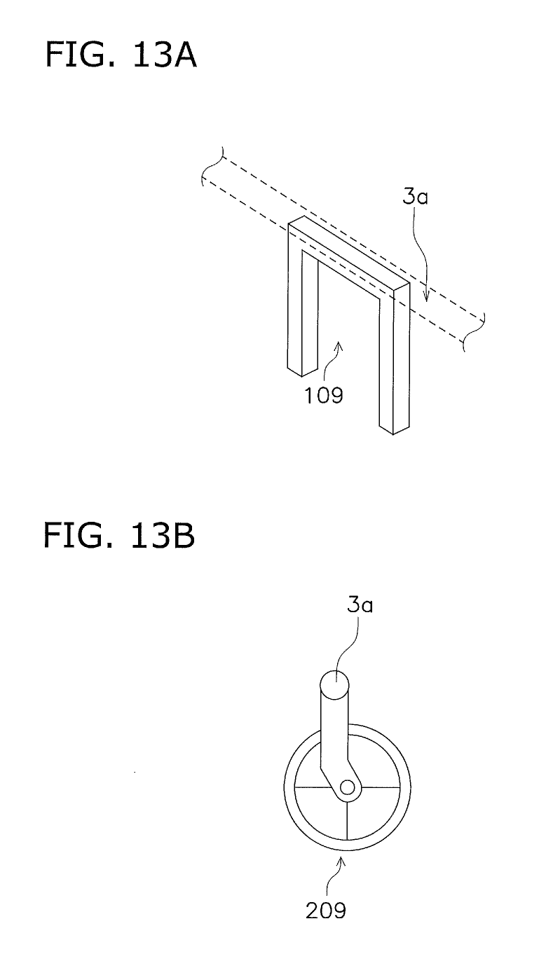

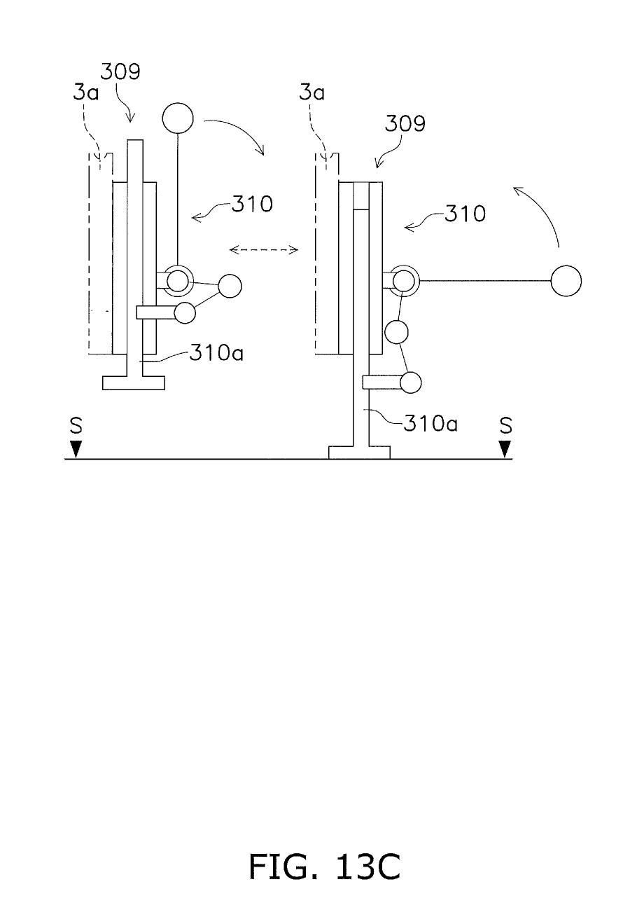

For example, as illustrated in FIG. 13A, a configuration is possible in which a support member 109 is formed in a C-shape having support legs. Alternatively, as illustrated in FIG. 13B, a configuration is possible in which a support member 209 is implemented as a wheel. Furthermore, as illustrated in FIG. 13C, a configuration is possible in which a support member 309 includes a support mechanism 310. In one example, this support mechanism 310 includes a support leg 310a that is extendable from the main body 3 toward the running surface S (the ground, for example).

(d) In the first and second embodiments, examples are described where the front wheels 5 and the rear wheels 7 are wheels. However, configurations are possible in which ball casters, crawlers, or the like are used for the front wheels 5 and the rear wheels 7. Note that, when ball casters are used, the first rotation axis J1 and/or the second rotation axis J2 are defined by the centers of the balls of the ball casters. Additionally, when crawlers are used, the first rotation axis J1 and/or the second rotation axis J2 are defined by the rotational center of any one of the plurality of rotating bodies of the crawlers.

### REFERENCE SIGNS LIST

1 Electric wheelchair
3 Wheelchair body
5 Front wheel
7 Rear wheel
9 Support member
10 Wheel
11 Motor
12 Electric Motor
13 Operating device
14 Wheelchair speed detection sensor
15 Object sensor
17 Step sensor
21 Control device
23 Drive control unit
25 First control release unit
27 Wheelchair speed control unit
29 Collision control unit
31 Derailing control unit
33 Direction control unit
35 Second control release unit
J1 First rotation axis
J2 Second rotation axis
C1, C2 Wheelbase
K1 Cross axis
M1 Caregiver
M2 Care receiver
T1 Tread of front wheel
T2 Tread of rear wheel

What is claimed is:

1. A moving apparatus rideable by a caregiver and operable by a motor, the moving apparatus comprising:
a main body;
a first rotating body mounted on the main body so as to be rotatable around a first rotation axis; and
a second rotating body mounted on the main body so as to be rotatable around a second rotation axis, the second rotation axis disposed spaced apart from the first rotation axis; wherein
the first rotating body and the second rotating body contact the ground; and
the main body is configured such that a wheelbase defined by the first rotation axis and the second rotation axis is changeable.

2. The moving apparatus according to claim 1, wherein
the main body is configured such that, when the caregiver and a care receiver assisted by the caregiver are riding on the main body, a center of gravity of the caregiver and a center of gravity of the care receiver are positioned within a range of the wheelbase.

3. The moving apparatus according to claim 2, wherein:
the main body includes a first frame portion where the care receiver assisted by the caregiver rides and a second frame portion where the caregiver rides;
the first rotating body is mounted on the first frame portion; and
the second rotating body is mounted on the second frame portion.

4. The moving apparatus according to claim 3, wherein
the wheelbase is changed by approaching or moving away of the second frame portion from the first frame portion.

5. The moving apparatus according to claim 3, wherein
the wheelbase is changed by folding of the second frame portion toward the first frame portion.

6. The moving apparatus according to claim 3, wherein
the first frame portion includes
a main frame portion connected to the second frame portion, and
a riding frame portion, where the care receiver assisted by the caregiver rides, detachably mounted on the main frame portion and including a third rotating body.

7. The moving apparatus according to claim 1, wherein:
one of the first rotating body and the second rotating body is configured from at least two rotating bodies; and
the other of the first rotating body and the second rotating body is configured from at least one rotating body.

8. The moving apparatus according to claim 1, wherein:
the first rotating body and the second rotating body are respectively configured from at least two rotating bodies;
a tread of the first rotating body is larger than a tread of the second rotating body; and
the second rotating body is mounted on the main body so as to rotate around a cross axis that intersects with the second rotation axis.

9. The moving apparatus according to claim 1, further comprising:
a support member supporting the main body between the first rotation axis and the second rotation axis when the wheelbase is changed.

10. The moving apparatus according to claim 1, further comprising:
a control device configured to control at least one of the first rotating body and the second rotating body.

11. The moving apparatus according to claim 10, wherein
the control device includes a first control unit, the first control unit configured to control a rotation speed of at least one of the first rotating body and the second rotating body so that a maximum trajectory of the first rotating body is greater than a maximum trajectory of the second rotating body.

12. The moving apparatus according to claim 11, wherein
the control device further includes a first setting unit, the first setting unit configured to set validity or invalidity of the control that is performed by the first control unit.

13. The moving apparatus according to claim 10, wherein
the control device includes a second control unit, the second control unit configured to control a steering angle of at least one of the first rotating body and the second rotating body so that the maximum trajectory of the first rotating body is greater than the maximum trajectory of the second rotating body.

14. The moving apparatus according to claim 13, wherein
the control device further includes a second setting unit, the second setting unit configured to set validity/invalidity of the control that is performed by the second control unit.

15. The moving apparatus according to claim 10, further comprising:
a first sensor configured to detect an object related to collision to a moving body or a stationary body; wherein
the control device includes a third control unit, the third control unit configured to control at least one of the first rotating body and the second rotating body so as to avoid the collision when the first sensor detects the object related to the collision.

16. The moving apparatus according to claim 10, further comprising:
a second sensor configured to detect an object related to derailment of at least one of the first rotating body and the second rotating body; wherein
the control device includes a fourth control unit, the fourth control unit configured to control at least one of the first rotating body and the second rotating body so as to avoid the derailment when the second sensor detects the object related to the derailment.

17. The moving apparatus according to claim 1, wherein
the first rotating body and the second rotating body are detachably mounted on the main body.

18. The moving apparatus according to claim 1, wherein
the rotating bodies from which the first rotating body and the second rotating body are respectively configured are wheels.

19. The moving apparatus according to claim 1, wherein
the rotating bodies from which the first rotating body and the second rotating body are respectively configured are at least one of wheels, ball casters, and crawlers.
